(19) United States
(12) Patent Application Publication
(10) Pub. No.: US 2026/0307223 A1
(43) Pub. Date: Oct. 8, 2026

(54) IMPACT TOOL WITH MAGNETICALLY ASSISTED IMPACT MECHANISM

(71) Applicant: MILWAUKEE ELECTRIC TOOL CORPORATION, Brookfield, WI (US)

(72) Inventor: Jay M. Klubertanz, Hartford, WI (US)

(21) Appl. No.: 19/642,313

(22) Filed: Apr. 8, 2026

Related U.S. Application Data
(60) Provisional application No. 63/785,428, filed on Apr. 8, 2025.

(51) Int. Cl. B25B 21/02

(52) U.S. Cl. CPC B25B 21/026

(57) ABSTRACT

An impact tool includes a housing, a motor supported within the housing, a drive assembly supported within the housing, the drive assembly including a camshaft driven by the motor for rotation about an axis, an anvil, a hammer configured to reciprocate along the camshaft to deliver rotational impacts to the anvil in response to rotation of the camshaft, a spring biasing the hammer towards the anvil, and a magnet configured to exert a magnetic biasing force on the hammer.

### CROSS-REFERENCE TO RELATED APPLICATIONS

The present application claims priority to U.S. Provisional Patent Application No. 63/785,428, filed Apr 8, 2025, the entire content of which is incorporated herein by reference.

### FIELD

The present disclosure relates to power tools, and more particularly to rotary impact tools.

### BACKGROUND

Impact tools or wrenches are typically utilized to provide a striking rotational force, or intermittent applications of torque to a tool element or workpiece (e.g., a fastener) to either tighten or loosen the fastener. A hammer is driven by a camshaft to retract against and store energy in a hammer spring, which may then propel the hammer forward along the camshaft, causing the hammer to rotate and deliver an impact to the anvil.

### SUMMARY

The hammer spring’s ability to store energy is a factor in how much rotational energy or torque is delivered from the hammer to the anvil. The size and strength of the hammer spring may also affect the timing of the impact mechanism. A need exists for an impact mechanism that can be fine tuned and/or store more energy than impact mechanisms relying on a hammer spring alone.

In some aspects, the techniques described herein relate to an impact tool including: a housing; a motor supported within the housing; a drive assembly supported within the housing, the drive assembly including: a camshaft driven by the motor for rotation about an axis, an anvil, a hammer configured to reciprocate along the camshaft to deliver rotational impacts to the anvil in response to rotation of the camshaft, a spring biasing the hammer towards the anvil, and a magnet configured to exert a magnetic biasing force on the hammer.

In some aspects, the techniques described herein relate to an impact tool including: a housing; a motor supported within the housing; a drive assembly supported within the housing, the drive assembly including: a camshaft driven by the motor for rotation about an axis; an anvil; a hammer configured to reciprocate along the camshaft to deliver rotational impacts to the anvil; a spring biasing the hammer toward the anvil; an electromagnet positioned to exert a selectable magnetic force on the hammer; and a controller configured to control current supplied to the electromagnet to vary an effective spring rate acting on the hammer during operation of the impact tool.

In some aspects, the techniques described herein relate to an impact mechanism for an impact tool, including: a camshaft configured to be rotatably driven about an axis; an anvil configured to receive rotational impacts; a hammer supported on the camshaft and movable axially relative to the camshaft between engaged and disengaged positions with the anvil; a spring biasing the hammer toward the anvil; and at least one magnetic element arranged to exert a magnetic force on the hammer that modifies axial movement of the hammer relative to the camshaft during operation.

Other features and aspects of the present disclosure will become apparent upon consideration of the following description and accompanying drawings.

### BRIEF DESCRIPTION OF DRAWINGS

FIG. 1 is a side partial cutaway view of a power tool according to an embodiment of the invention.

FIG. 2 is a cross-sectional view of the power tool of FIG. 1, illustrating an impact mechanism.

FIG. 3 is a cross-sectional view illustrating an impact mechanism embodying aspects of the present disclosure and which may be incorporated into the power tool of FIG. 1.

FIG. 4 is a cross-sectional view illustrating an impact mechanism according to another embodiment of the present disclosure and which may be incorporated into the power tool of FIG. 1.

FIG. 5 is a cross-sectional view illustrating an impact mechanism according to another embodiment of the present disclosure and which may be incorporated into the power tool of FIG. 1.

FIG. 6 is a cross-sectional view illustrating an impact mechanism according to another embodiment of the present disclosure and which may be incorporated into the power tool of FIG. 1.

Before any embodiments of the disclosure are explained in detail, it is to be understood that the disclosure is not limited in its application to the details of construction and the arrangement of components set forth in the following description or illustrated in the following drawings. The disclosure is capable of other embodiments and of being practiced or of being carried out in various ways. Also, it is to be understood that the phraseology and terminology used herein is for the purpose of description and should not be regarded as limiting.

### DETAILED DESCRIPTION

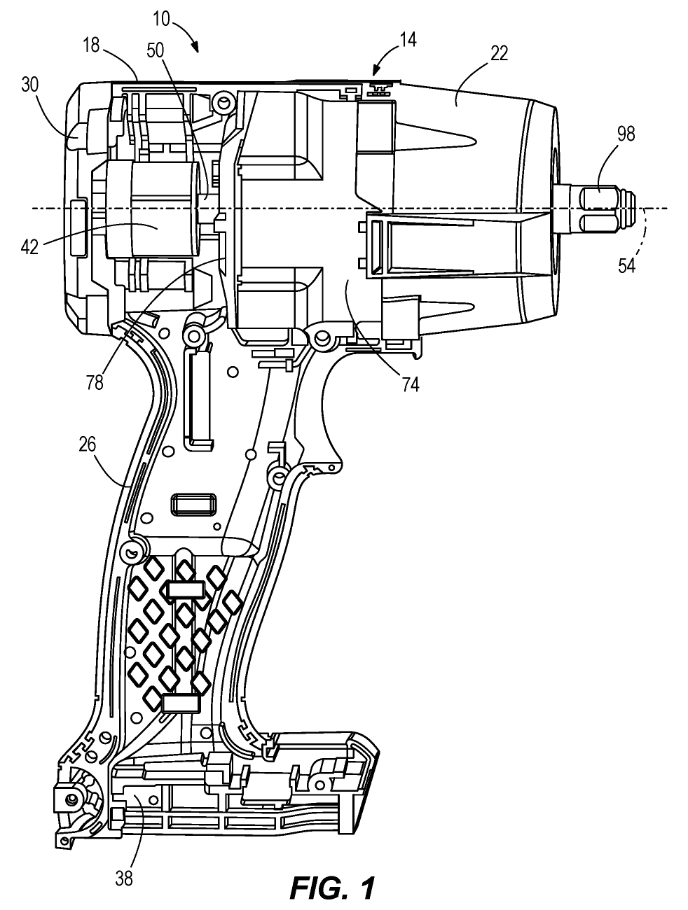

FIG. 1 illustrates an exemplary impact tool 10 including a housing 14 with a motor housing portion 18, a gear case or front housing portion 22 coupled to the motor housing portion 18 (e.g., by a plurality of fasteners), and a handle portion 26 extending downwardly from the motor housing portion 18. In the illustrated embodiment, the housing 14 further includes a back cap 30 coupled to the motor housing portion 18 opposite the front housing portion 22.

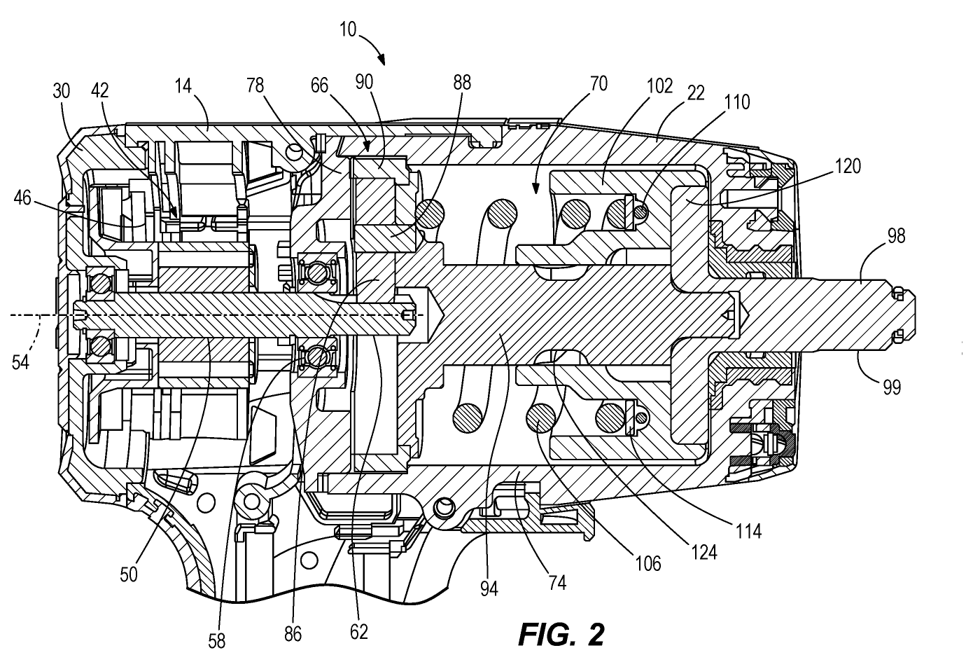

The impact tool 10 has a battery (not shown) removably coupled to a battery receptacle 38 located at a bottom end of the handle portion 26. An electric motor 42, supported within the motor housing portion 18, receives power from the battery via the battery receptacle 38 when the battery is coupled to the battery receptacle 38. In the illustrated embodiment, the motor 42 is a brushless direct current (“BLDC”) motor with a stator 46 (FIG. 2) and an output shaft or rotor 50 that is rotatable about an axis 54 relative to the stator 46. In other embodiments, other types of motors may be used.

The impact tool 10 also includes a switch (e.g., trigger switch; not shown) supported by the housing 14 that selectively electrically connects the motor 42 and the battery via a controller (including, amongst other components, a printed circuit board having one or more microprocessors and multiple field-effect transistors) to provide power to the motor 42. In other embodiments, the impact tool 10 may include a power cord for electrically connecting the switch and the motor 42 to a source of AC power. As a further alternative, the impact tool 10 may be configured to operate using a different power source (e.g., a pneumatic or hydraulic power source, etc.).

Referring to FIG. 2, the impact tool 10 further includes a gear assembly 66 coupled to the motor output shaft 50 and an impact mechanism or drive assembly 70 coupled to an output of the gear assembly 66. The gear assembly 66 may be configured in any of a number of different ways to provide a speed reduction between the output shaft 50 and an input of the drive assembly 70. The gear assembly 66 is at least partially housed within a main body portion 74 of the gear case 22. The gear case 22 further includes a rear end cap 78 fixed to the main body portion 74 (e.g., by a plurality of fasteners, a press-fit, a threaded connection, or in any other suitable manner). The rear end cap 78 of the gear case 22 supports a bearing 58, which rotationally supports a front portion of the output shaft 50 of the motor 42. In some embodiments, the bearing 58 is insert molded within the rear end cap 78. In other embodiments, the radial bearing 58 may be press-fit within the rear end cap 78.

With reference to FIG. 2, the gear assembly 66 includes a pinion 62 formed on the motor output shaft 50, a plurality of planet gears 86 meshed with the pinion 62, and a ring gear 90 meshed with the planet gears 86 and rotationally fixed within the gear case 22. The planet gears 86 orbit about the pinion 62 within the ring gear 90 and are each supported by a plurality of pins 88. The pins 88 are received in respective recesses on a camshaft 94 of the drive assembly 70, such that the camshaft 94 acts as a planet carrier. Accordingly, rotation of the motor output shaft 50 rotates the planet gears 86, which then advance along the inner circumference of the ring gear 90 to rotate the camshaft 94.

In the illustrated embodiment of the impact tool 10, the drive assembly 70 includes the camshaft 94, a hammer 102 supported on and axially slidable relative to the camshaft 94, and an anvil 98 (FIG. 2). The anvil 98 extends through a front end of the gear case 22 and includes a drive interface 99 (e.g., a square drive interface, a hex drive interface, a spline drive interface, or the like) to which a tool element (e.g., a socket or a hex-shank tool bit, not shown) can be coupled for performing work on a workpiece (e.g., a fastener). The impact tool 10 may be any of a variety of impact tool types, such as an impact wrench or an impact driver. The drive assembly 70 is configured to convert a continuous rotational force or torque, provided by the motor 42 via the gear assembly 66, to a striking rotational force or intermittent applications of torque to the anvil 98 when the reaction torque on the anvil 98 (e.g., due to engagement between the tool element and a fastener being worked upon) exceeds a certain threshold.

With continued reference to FIG. 2, the drive assembly 70 further includes a spring 106 biasing the hammer 102 toward the front of the impact tool 10 (i.e., in the right direction of FIG. 2). In other words, the spring 106 biases the hammer 102 in an axial direction toward the anvil 98, along the axis 54. A thrust bearing 110 and a thrust washer 114 are positioned between the spring 106 and the hammer 102. The thrust bearing 110 and the thrust washer 114 allow for the spring 106 and the camshaft 94 to continue to rotate relative to the hammer 102 after each impact strike when lugs (not shown) on the hammer 102 engage with corresponding anvil lugs 120 and rotation of the hammer 102 momentarily stops. The camshaft 94 further includes cam grooves 124 in which corresponding cam balls (not shown) are received. The cam balls are in driving engagement with the hammer 102, and movement of the cam balls within the cam grooves 124 allows for relative axial movement of the hammer 102 along the camshaft 94 when the hammer lugs and the anvil lugs 120 are engaged and the camshaft 94 continues to rotate.

In operation of the impact tool 10, an operator depresses the switch to activate the motor 42, which continuously drives the gear assembly 66 and the camshaft 94 via the output shaft 50. As the camshaft 94 rotates, the cam balls drive the hammer 102 to co-rotate with the camshaft 94, and the drive surfaces of the hammer lugs engage, respectively, the driven surfaces of the anvil lugs 120 to provide an impact and to rotatably drive the anvil 98 and the tool element. After each impact, the hammer 102 moves or slides rearward along the camshaft 94, away from the anvil 98, so that the hammer lugs disengage the anvil lugs 120. As the hammer 102 moves rearward, the cam balls situated in the respective cam grooves 124 in the camshaft 94 move rearward in the cam grooves 124. The spring 106 stores some of the rearward energy of the hammer 102 to provide a return mechanism for the hammer 102. After the hammer lugs disengage the respective anvil lugs 120, the hammer 102 continues to rotate and moves or slides forwardly, toward the anvil 98, as the spring 106 releases its stored energy, until the drive surfaces of the hammer lugs re-engage the driven surfaces of the anvil lugs 120 to cause another impact.

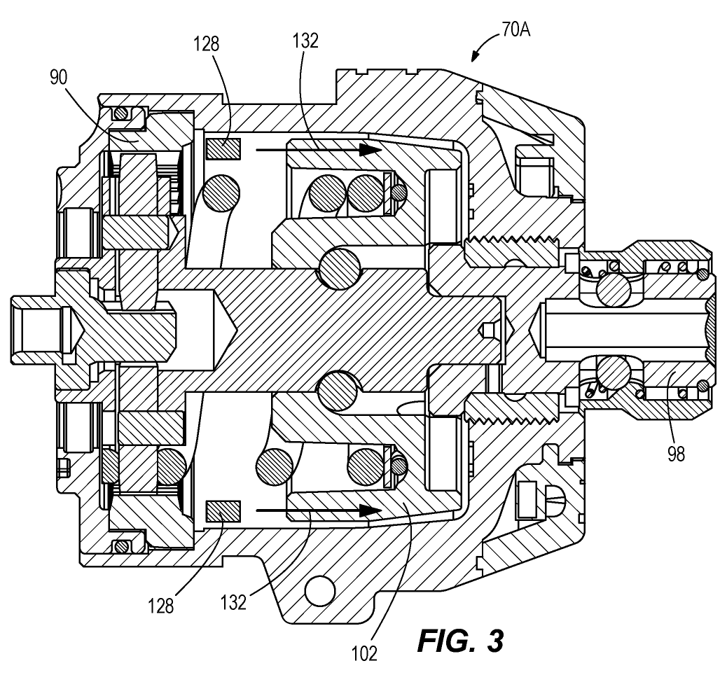

The spring rate of the spring 106, the mass of the hammer 102, and the profile of the cam grooves 124, all help determine the hammer timing, which is how quickly the hammer 102 moves forwardly and rearwardly as the impact tool 10 is operated. FIGS. 3-6 illustrate drive assemblies 70A, 70B, 70C, 70D embodying aspects of the present disclosure, which may be incorporated into the impact tool 10 in place of the drive assembly 70. Each of the drive assemblies 70A, 70B, 70C includes one or more magnets 128 that exert a magnetic biasing force on the hammer 102. In this way, the magnets 128 can adjust the hammer timing, the trip torque (i.e., at what torque on the anvil the hammer begins to retract along the camshaft 94 and begin cycles of impacting the anvil 98), and the energy delivered from the hammer 102 to the anvil 98.

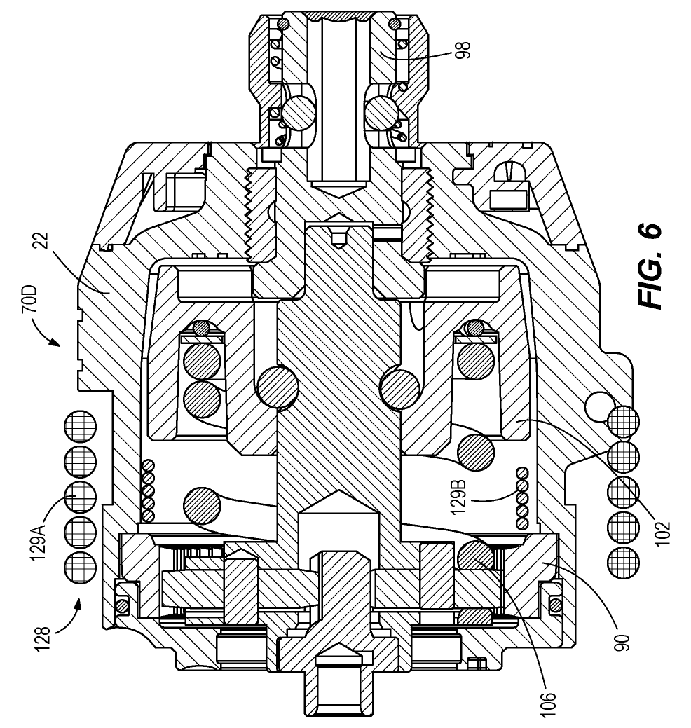

The magnets 128 may be permanent magnets. In other embodiments, the magnets 128 may include an electromagnet (FIG. 6), able to be selectively energized during operation of the impact tool 10 and powered by a power source (e.g., battery) of the impact tool 10. In some embodiments, the hammer 102 is magnetized prior to assembly such that it attracts or repels the magnets 128, depending on the polarity of the magnets 128. Alternatively, additional magnets (not shown) can be coupled to the hammer 102 to achieve the same attraction or repulsion with the magnets 128.

Referring to FIG. 3, in one embodiment, the magnets 128 repel the hammer 102 and assist the spring 106 in forcing the hammer 102 to move forward (in the direction of arrow 132) towards the anvil 98. As the hammer 102 moves rearward, the repulsive force the magnets 128 exert on the hammer 102 increases. When the hammer lugs disengage the respective anvil lugs 120, the hammer 102 moves forwardly as the spring 106 and the magnets 128 both impart a force on the hammer 102, thus increasing the overall spring force acting on the hammer 102. This configuration may help to prevent the drive assembly 70 from crashing when operating on stiffer joints, for example, and may also increase the amount of energy delivered from the hammer 102 to the anvil 98.

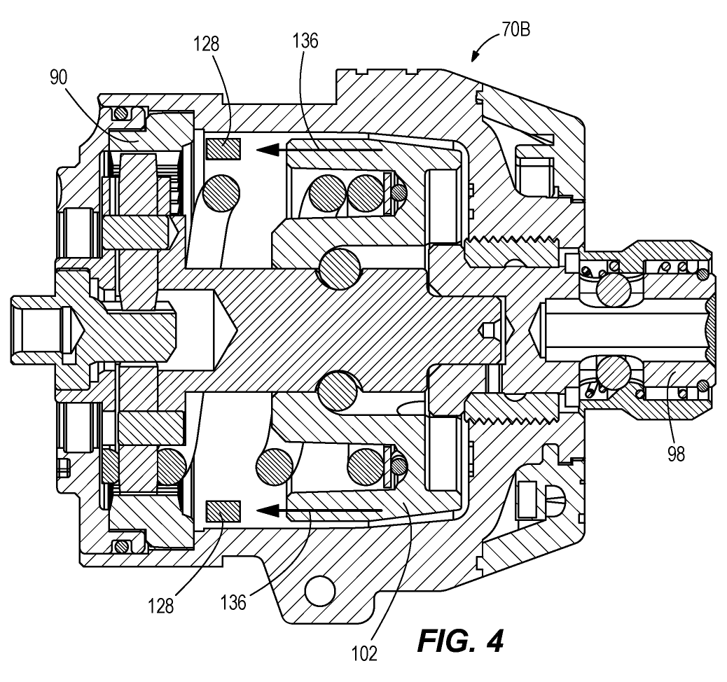

Referring to FIG. 4, in another embodiment, the magnets 128 attract the hammer 102, pulling the hammer 102 rearward in the direction of arrow 136 and assisting the hammer 102 to compress the spring 106. As the hammer 102 moves rearward, the force the magnets 128 exert on the hammer 102 increases, directly opposing the force of the spring 106 and thus reducing the overall effective spring rate. The magnets 128 can be coupled to the interior of the gear case 22, and the axial position of the magnets 128 relative to the camshaft 94 directly affects the force the magnets 128 exert on the hammer 102 as it moves rearwardly. By reducing the spring rate, the trip torque of the drive assembly 70B may be reduced.

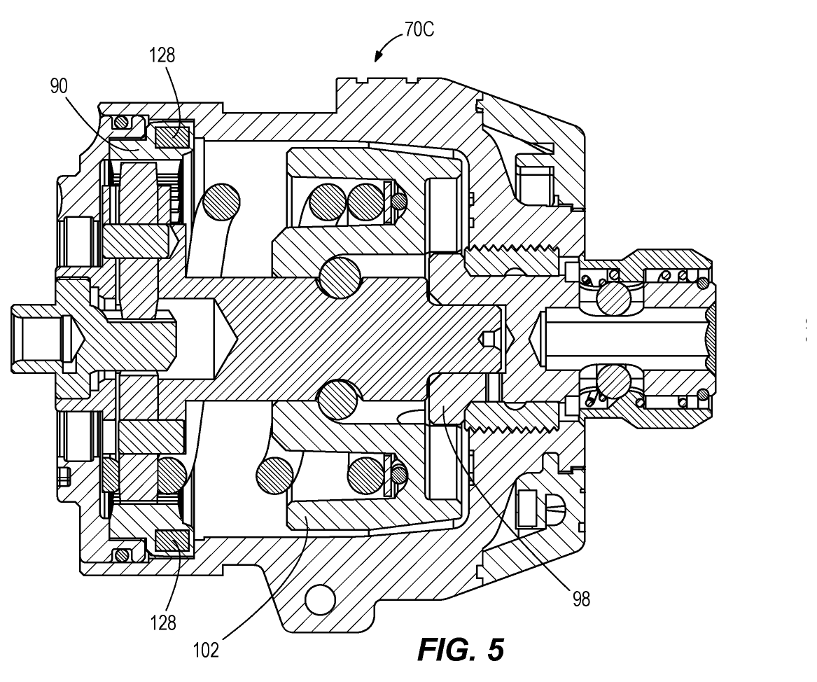

According to FIG. 5, in another embodiment, the magnets can be coupled to the ring gear. Alternatively, in place of the magnets 128, the ring gear 90 can be magnetized such that it either repels or attracts the hammer 102. The same effects of attraction or repulsion would apply to the ring gear 90. When the ring gear 90 repels the hammer 102, the overall spring force is increased. When the ring gear 90 attracts the hammer 102, the overall spring rate is reduced.

FIG. 6 illustrates an embodiment of a drive assembly 70D in which the magnet 128 is an electromagnet. The electromagnet 128 may include a first coil 129A surrounding an exterior of the gear case 22, and/or a second coil 129B located inside the gear case 22 between the hammer 102 and the ring gear 90. In some embodiments, the first coil 129A and/or the second coil 129B may be encased in an overmolded nonmetallic material or with potting material.

Current may be supplied through the coil(s) 129A, 129B of the electromagnet 128 in a first direction to generate a magnetic field acting on the hammer 102 to bias the hammer 102 toward the anvil 98 and thereby increase the effective spring rate of the drive assembly 70D, or in a second, opposite direction to generate a magnetic field acting on the hammer 102 to bias the hammer 102 away from the anvil 98 and thereby decrease the effective spring rate of the drive assembly 70D.

In some embodiments, the current supplied through the coil(s) 129A, 129B may be a constant current activated when the trigger of the impact tool 10 is depressed. In other embodiments, the current supplied through the coil(s) 129A, 129B may be a variable current dynamically controlled by a controller of the impact tool 10. In such embodiments, the controller may vary the current as a function of the current supplied to the electric motor 42. For example, the controller may supply a greater amount of current to the coil(s) 129A, 129B in the first direction to provide a greater increase in the effective spring rate during high load conditions, thereby providing greater impact energy delivered from the hammer 102 to the anvil 98. In another example, the controller may reverse the direction of current during low load conditions, thereby decreasing the effective spring rate and decreasing the trip torque.

Although the disclosure has been described in detail with reference to certain preferred embodiments, variations and modifications exist within the scope and spirit of one or more independent aspects of the disclosure as described.

Various features and aspects of the present disclosure are set forth in the following claims.

What is claimed is:

1. An impact tool comprising:
a housing;
a motor supported within the housing;
a drive assembly supported within the housing, the drive assembly including:
a camshaft driven by the motor for rotation about an axis,
an anvil,
a hammer configured to reciprocate along the camshaft to deliver rotational impacts to the anvil in response to rotation of the camshaft,
a spring biasing the hammer towards the anvil, and
a magnet configured to exert a magnetic biasing force on the hammer.

2. The impact tool of claim 1 wherein the hammer is magnetized.

3. The impact tool of claim 1, wherein the magnetic biasing force is a repulsive force biasing the hammer towards the anvil.

4. The impact tool of claim 1, wherein the magnetic biasing force is an attractive force biasing the hammer away from the anvil.

5. The impact tool of claim 1, further comprising a gear assembly coupled between the motor and the camshaft, the gear assembly including a ring gear, wherein the magnet is coupled to the ring gear.

6. The impact tool of claim 1, wherein the magnet is one of a plurality of magnets.

7. The impact tool of claim 1, wherein the magnetic biasing force is adjustable.

8. The impact tool of claim 1, wherein the magnet is an electromagnet.

9. An impact tool comprising:
a housing;
a motor supported within the housing;
a drive assembly supported within the housing, the drive assembly including:
a camshaft driven by the motor for rotation about an axis;
an anvil;
a hammer configured to reciprocate along the camshaft to deliver rotational impacts to the anvil;
a spring biasing the hammer toward the anvil;
an electromagnet positioned to exert a selectable magnetic force on the hammer; and
a controller configured to control current supplied to the electromagnet to vary an effective spring rate acting on the hammer during operation of the impact tool.

10. The impact tool of claim 9, wherein the controller is configured to vary the current supplied to the electromagnet as a function of load on the anvil.

11. The impact tool of claim 9, wherein the controller is configured to increase the current supplied to the electromagnet to bias the hammer toward the anvil during high load conditions.

12. The impact tool of claim 9, wherein the controller is configured to reverse a direction of current supplied to the electromagnet to bias the hammer away from the anvil during low load conditions.

13. The impact tool of claim 9, wherein the electromagnet includes a coil positioned radially outward of the hammer.

14. The impact tool of claim 9, wherein the electromagnet includes a coil positioned axially between the hammer and a ring gear of a gear assembly.

15. The impact tool of claim 9, wherein the controller supplies a variable current to the electromagnet in response to motor current.

16. An impact mechanism for an impact tool, comprising:
a camshaft configured to be rotatably driven about an axis;
an anvil configured to receive rotational impacts;
a hammer supported on the camshaft and movable axially relative to the camshaft between engaged and disengaged positions with the anvil;
a spring biasing the hammer toward the anvil; and
at least one magnetic element arranged to exert a magnetic force on the hammer that modifies axial movement of the hammer relative to the camshaft during operation.

17. The impact mechanism of claim 16, wherein the magnetic element is coupled to a gear case surrounding the camshaft.

18. The impact mechanism of claim 16, wherein the magnetic element is coupled to a ring gear surrounding the camshaft.

19. The impact mechanism of claim 16, wherein the magnetic element is configured to repel the hammer and increase an effective spring force acting on the hammer.

20. The impact mechanism of claim 16, wherein the magnetic element is configured to attract the hammer and reduce an effective spring force acting on the hammer.
